(19) United States
(12) Patent Application Publication
(10) Pub. No.: US 2010/0095567 A1
(43) Pub. Date: Apr. 22, 2010

(54) Handle with Advertising Areas

(75) Inventor: Hang Li, Beijing (CN)

Correspondence Address: Hang Li, 113 N Quarry St., Ithaca, NY, 14850, US

(73) Assignee: Hang Li, Ithaca, NY (US)

(21) Appl. No.: 12/254,929

(22) Filed: Oct. 21, 2008

(51) Int. Cl. G09F 3/00

(52) U.S. Cl. 40/318

(57) ABSTRACT

A handle with advertising areas is an advertisement display device for use on the poles in bus, subway, and so on. The device can be installed on and removed from a handrail easily and can help people hold on easier and better than on handrail. This device has a fixing part and a handle part connecting by a knitting strip ring. The device has five gaps to hold advertisement sheets and dispensing tracts. Advertisement sheet and tracts can be removably inserted into a gap. Each tract has an exposed end outside the handle part for people to take it out. Fastening members are provided for clamping the multi-piece device onto a handrail.

### BACKGROUND OF THE INVENTION

1. Field of the Invention

The present invention relates generally to a handle with advertising areas which can be fixed on a handrail in places like subway and bus. In particular, this invention relates to a device allowing people to hold on more easily than on handrail while it relates a device to hold for both stable advertisements and dispensing tracts.

2. The Prior Art

When people take bus or subway, they usually feel bored and seek for anything can draw their attention, like advertisements. Also because of the huge amount passengers, advertisements in bus or subway become an effective and important way for companies to broadcast their desired information to customers and clients. Currently advertisements inside bus or subway are usually placed on window or in the corner of ceiling and wall. However, there are many drawbacks for current advertisement forms like this inside bus or subway. First of all, the advertisement area is limited to the places like windows or walls. Secondly, advertisements may be too far for people with visual defects to see. Thirdly, during the rush hour, most people cannot see the advertisement because other people may block their view. Last but not least, even when people are interested in the information conveyed by a particular advertisement, they are unlikely to put down any anything, like company name, phone number, and website; hence, usually people will not remember the advertisement they saw after they get off. Because of these reasons, current form of advertisements in bus or subway fails to be a strongly efficient way of transmitting information to passengers.

Advertisement device clamping on pole has previously been seen. Prior U.S. Pat. No. 5,301,443, SHOPPING CART HANDLE ADVERTISING DISPLAY DEVICE, describes an advertising display device that can clamp onto the handle of a shopping cart.

Bus handle or strip which can be fixed on handrail in a bus has also been utilized widely nowadays. When people hold on pole, sweaty palms may be slippery and cause danger. Also in winter, people feel cold when hold on pole. Pole handle has been seen previously. Current handrail handle can help standing people in bus to hold better and more comfortable.

However, until now, there has not been seen a handrail handle device with advertising areas in a bus or subway, especially the idea of a device for holding both stable advertisements and dispensing tracts. Accordingly, there is a need for handles with advertising areas to be installed on handrail in bus or subway, because it realizes a more effective way of advertising comparing with the current advertisement forms, which have previous mentioned drawbacks, in bus and subway, while it enables people in bus or subway to hold on more easily and comfortably.

### SUMMARY OF THE INVENTION

It is an object of the invention to provide a better way for people to hold on than poles do. This invention contains an upper part, as the fixing part, and a lower part, as the handle part. The bottom portion of handle part has a shape fitting people's hand. Connecting by knitting strip ring, upper part and lower part can connect within any relative angle, so people can hold the handle part in any direction they prefer.

It is another object of the invention to allow advertisements to display on an existing handrail in bus or subway. Accordingly, the present invention employs several parts which can clamp onto existing pole while allow both stable advertisements and dispensing tracts to be inserted into gaps.

It is yet another objective of the invention to provide an advertisement device that is attractive and highly visible. Accordingly, the brackets are preferably made of transparent plastic, such as polycarbonate, so as to allow people to see the advertisement inserted inside the frame. Fixed on pole, this invention allows the advertisements inside to be presented to passenger in various directions.

It is a further object of the invention to realize a more effective way of advertising. Besides stable advertisement, the present invention allows dispensing tracts to be placed inside and to be taken away by people. The tracts can be anything desired, as long as it can be inserted into gaps, such as coupons and business card of contact information. With a disposed end outside the frame, a tract can be taken out by people without disturbing other presenting advertisements inside.

The invention is a handle with advertisement areas, for use in conjunction with an existing handrail inside bus or subway. The present invention comprises a multipiece body which, preferably, has a fixing part and a handle part that are connected by a knitting strip ring. The fixing part includes, in the preferred embodiment, two identical frames in complementary shapes fitting to a handrail. The two frames of a fixing part are fixed by three fasteners, one of which also connects to the knitting strip ring. The fixing part has to on gaps on each frame to hold advertisement sheets. The handle part, in preferred embodiment, has a double-side advertisement displacement area combines a handle portion at the bottom in the shape of fitting people's hands. At the middle top of the handle part, a hole allows the knitting strip ring to go through. The handle part, preferably, has three gaps in the advertisement area: the middle gap can be used for holding dispensing tracts, while the other two can be used for holding stable advertisement sheets. A dispensing tract has an exposed end, which allows people to take it out without disturbing other the advertisements inside or the handle device.

To the accomplishment of the above and related objects the invention may be embodied in the form illustrated in the accompanying drawings. Attention is called to the fact, however, that the drawings are illustrative only. Variations are contemplated as being part of the invention, limited only by the scope of the claims.

### BRIEF DESCRIPTION OF THE DRAWINGS

In the drawings, like elements are depicted by like reverence numerals. The drawings are briefly described as follows.

FIG. 1 is a bottom view and front view of a preferred fixing frame, accompanying with left section views of the whole fixing part which comprises two identical fixing parts fitting together.

FIG. 2 is a right view, and front view of a preferred fixing part, accompanying with bottom section views of the whole fixing part with comprises two identical fixing parts fitting together.

FIG. 3 is a left view of the fixing part being selectively mounted onto a handrail and connected to a knitting strip ring and a handle part.

FIG. 4 is a top view of the fixing part being selectively mounted and connected to a knitting strip ring and handle part.

FIG. 5 is a perspective view of the fixing part being selectively mounted onto a handrail and connected to a knitting strip ring and a handle part.

FIG. 6 is a front view of the fixing part mounted onto a pole and connected to a knitting strip ring and a handle part.

FIG. 7 is a perspective view of the whole present invention being used in conjunction with a handrail in bus or subway, while stable advertisements and dispersing tracts are placed inside frames.

### DETAILED DESCRIPTION OF THE PREFERRED EMBODIMENTS

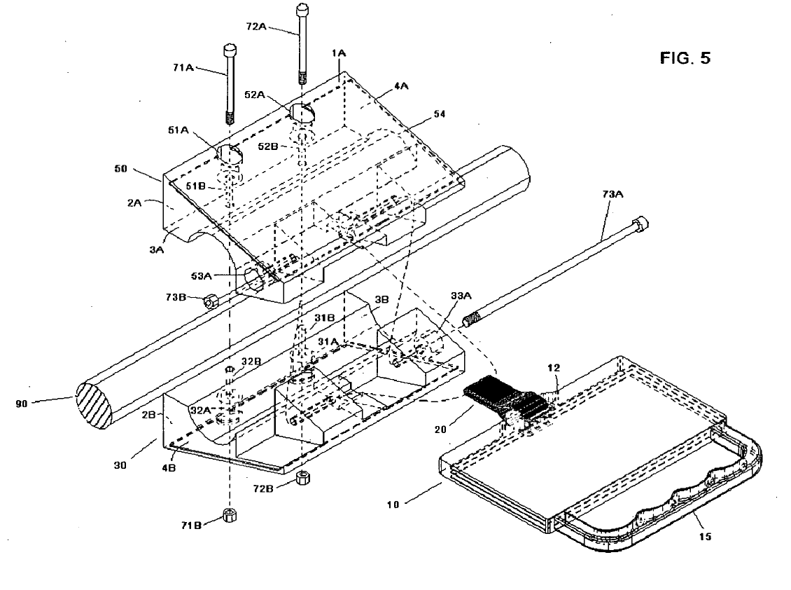

The present invention is generally shown in FIG. 5. A fixing part has two identical fixing frames 30 and 50 placed in opposite direction with shape complementary to each other and fitting to the handrail 90. The handle part 10 is an integrated part with a hole 12 for knitting strip ring 20 to go through. Both fixing part (frames 30, 50) and handle part 10 are molded from a suitable transparent material like plastic.

Fixing frame 50 has two fastener receptacles 51A and 52B at the front face 1A. Receptacle 51A is located generally at upper left of front face 1A. Receptacle 52A is located generally at upper right of front face 1A. A fastener receptacle has an internal receiving bore formed therein through which a fastener can be received. More specifically, fastener receptacle 51A has receiving bore 51B formed therein. A suitable fastener, such as screw 71A, is passed through receptacle 51A and receiving bore 51B. A corresponding receiving bore 32B and receptacle 32A are formed in fixing frame 30. Fastener 71A is passed through receiving bore receiving bore 51B and then into receiving bore 32B and receptacle 32A. A locking nut 71B is used to lock fastener 71A in place. Similarly, screw 72A passes through receptacle 52A and receiving bore 52B into receiving bore 31B and receptacle 31A. A locking nut 72B is used to secure screw 72A in place. Because fixing frame 50 and 30 are identical but in opposite direction, the relative position of 31A, 31B, 32A, and 32B to fixing frame 30 is the same as 51A, 51B, 52A, and 52B to fixing frame 50.

Other type of fasteners may be used such as rivets, self-tapping screws and the like.

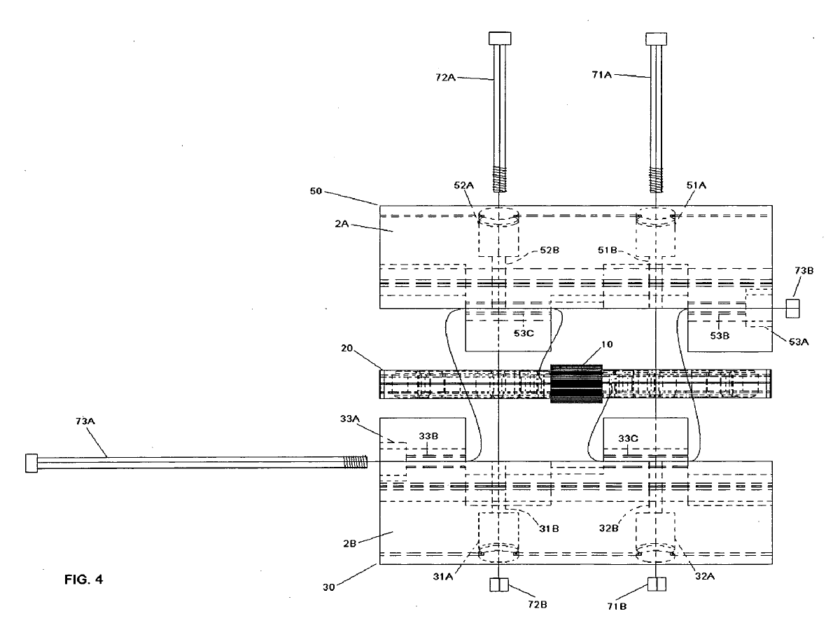

FIG. 4 shows the top view (viewing down at top face 2A and 2B) of the present invention being mounted. FIG. 4 further depicts the manner in which the fixing frames 50 and 30 are composed by fasteners 71A, 72A, and 73A. Fastener 71A goes through receptacle 51A, bore 51B in fixing frame 50 and then bore 32B, receptacle 32A in fixing frame 30. Fastener 72A goes through receptacle 52A, bore 52B in fixing frame 50 and bore 31B, receptacle 31A in fixing frame 30. Fasteners 71A and 72A are secured by locking nut 71B in receptacle 32A and 72B in receptacle 31A respectively.

After fixing frames 30 and 50 are clamped on pole 90, receptacle 33A, bores 33B and 33C in fixing frame 30 will be in the same line as receptacle 53A, bores 53B and 53C in fixing frame 50. Then fastener 73A can go through receptacle 33A and receiving bore 33B in fixing frame 30, bore 53C in fixing frame 50, knitting strip ring 20, bore 33C in fixing frame 30, and receiving bore 53B and receptacle 53A in fixing frame 50. A locking nut 73B, placed in receptacle 53A, will secure fastener 73A. Notice that a small cylindrical shall (not drawn), in the material like plastic, can be placed between fastener 73A and knitting strip ring 20 to reduce abrasion of knitting strip ring caused by long-term use.

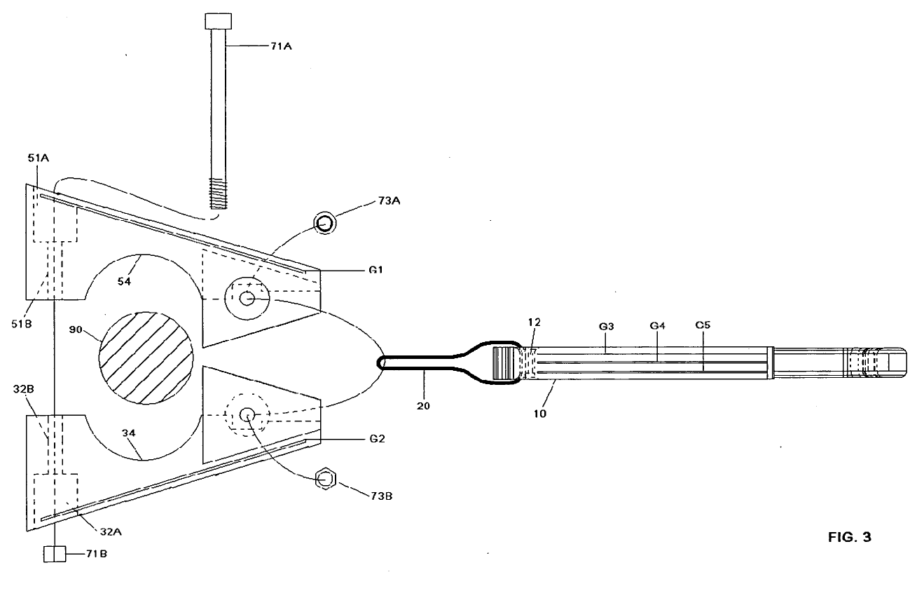

FIG. 3 shows the left-side view (viewing rightward at left face 3A on fixing frame 50 and right face 4B on fixing frame 30) of the present invention being mounted. FIG. 3 further depicts the manner in which the fixing frame 50 and 30 are camped onto handrail 90. With semicircular-like shape, groove 54 in fixing frame 50 and groove 34 in fixing frame 30 form an empty space similar to a cylinder between fixing frames 50 and 30. This empty cylindrical space allow handrail 90 to go through, and further, frames 50 and 30 to be fixed on handrail 90. In addition, a gasket (not drawn), such as grooved rubber gasket, can be placed between fixing part and handrail 90 to ensure that fixing part is fixed firmly and tightly on pole 90.

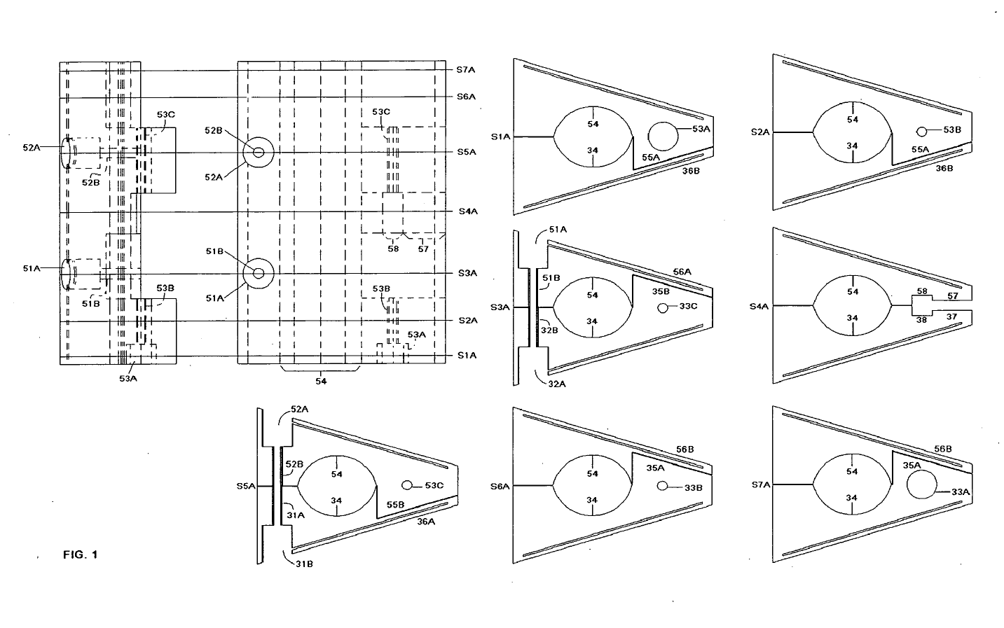

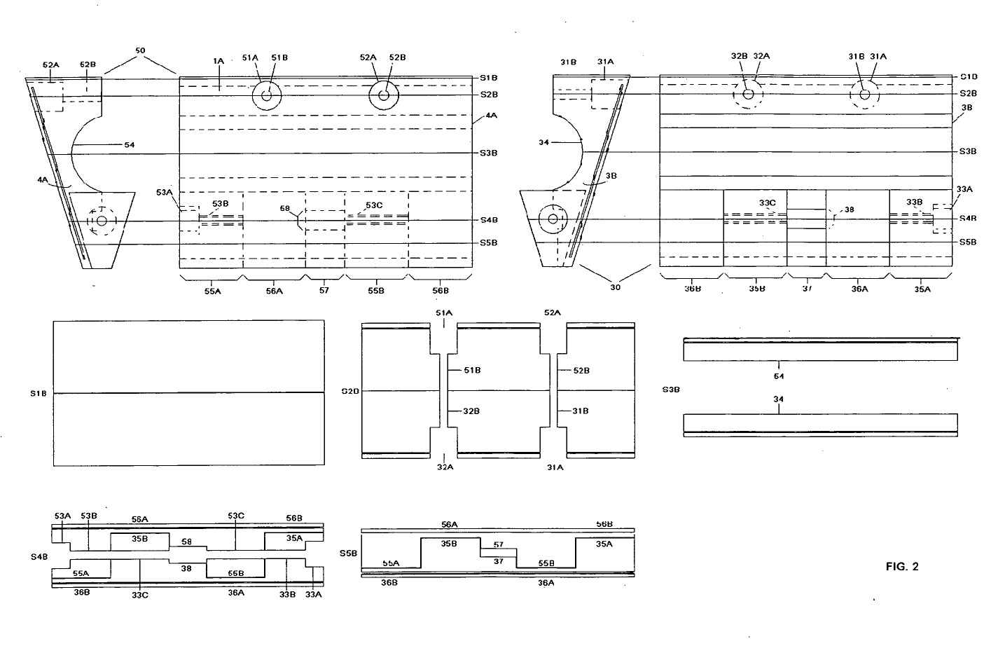

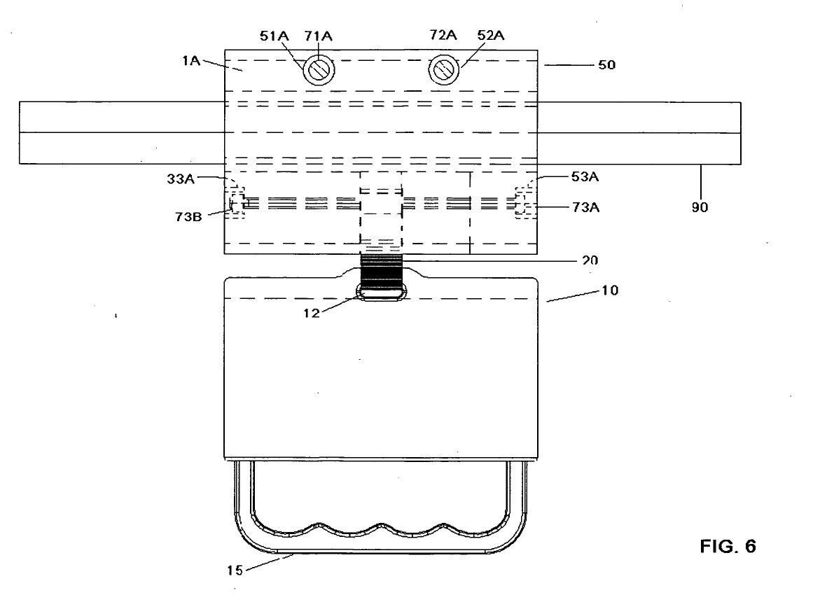

FIGS. 1 and 2 shows the shape of a fixing frame in detail and how two identical fixing frames, 30 and 50 in opposite direction, can be composed to each other. FIG. 1 shows the bottom view and front-view of fixing frame 50 along with corresponding left view of cross sections S1A, S2A, S3A, S4A, S5A, S6A and S7A after composing fixing frames 50 and 30 together. FIG. 2 shows the right view and front view of fixing frames 50 and 30 along with the corresponding bottom view of cross section S1B, S2B, S3B, S4B, and S5B after composing fixing frames 50 and 30 together. As shown in FIGS. 1 and 2, fixing frame 50 has protruding parts 55A and 55B, and receding part 56A, 56B, 57 and 58; similarly, fixing frame 30 has protruding parts 35A and 35B, and receding part 36A, 36B, 37 and 38. Notice that fixing frame 50 and 30 are identical but in opposite direction. So relative positions of 55A, 55B, 56A, 56B, 57, and 58 to fixing frame 50 is the same as that of 35A, 35B, 36A, 36B, 37 and 38 to fixing frame 30. When composed fixing frames 50 and 30 together, protruding part 55A fits into receding part 36B as shown in section views S1A, S2A, S4B, and S5B; receding part 56A receives protruding part 35B as show in section view S3A, S4B, and S5B; protruding part 55B fits into receding part 36A as shown in section views S5A, S4B, and S5B; and receding part 56B will receive protruding part 35A as show in section view S5A, S6A, S4B, and S5B. Receding parts 57 and 37 together form a cuboid space allow knitting strip ring 20 to go through and reach the cuboid space formed by receding parts 58 and 38. In cuboid space formed by receding parts 58 and 38, knitting strip ring 20 is went through by fastener 73A as shown in FIG. 6. In addition, receptacles 54 and 34 will form an empty cylindrical like space to low pole 90 to for fixing flames 50 and 30 clamping onto it, as shown in SA1 to SA7 and SB3. Receptacle 51A, bore 51B, bore 32B, and receptacle 31A lay in the same line, as shown in S3A and S2B; Receptacle 52A, bore 52B, bore 31B and receptacle 31A lay in the same line, as shown in S5A and S2B; Receptacle 53A, bore 53B, bore 33C, bore 53C, bore 33B, and receptacle 33A lay in same line, as shown in S4B. Depicted previously, a shape of fixing frame like this allows two identical fixing frames, 50 and 30 in opposite direction, complementary fitting to each other, clamping onto handrail 90, and connecting to knitting strip ring 20.

Gaps G1 and G2 are in fixing frame 50 and 30 respectively; Gaps G3, G4 and G5 are in handle part 10 (FIG. 3). The present invention has gaps G1 to G5 to hold stable advertisement sheets and dispensing tracts. Because the fixing frames 50 and 30 and handle part 10 are made of transparent material, like plastic, advertisement sheets in gaps G1, G2, G3 and G5 can be viewed from outside. If advertisements are placed in Gaps G3 and G5, gap G4 is invisible form outside. G4 is preferred to be used as a gap to hold dispensing tracts like coupons or business cards of contact information. The length of two dispensing tracts in same level is preferred to be longer than the length of handle part 10 so that people can hold the exposed end of tracts and take it out form handle part 10. Notice that additional frame (not shown in FIGS), like a slice of plastic, can be placed into gap G4 to better hold tracts in positions. In other applications, the gaps G1 to G5 can hold anything desired to be displayed or handed around.

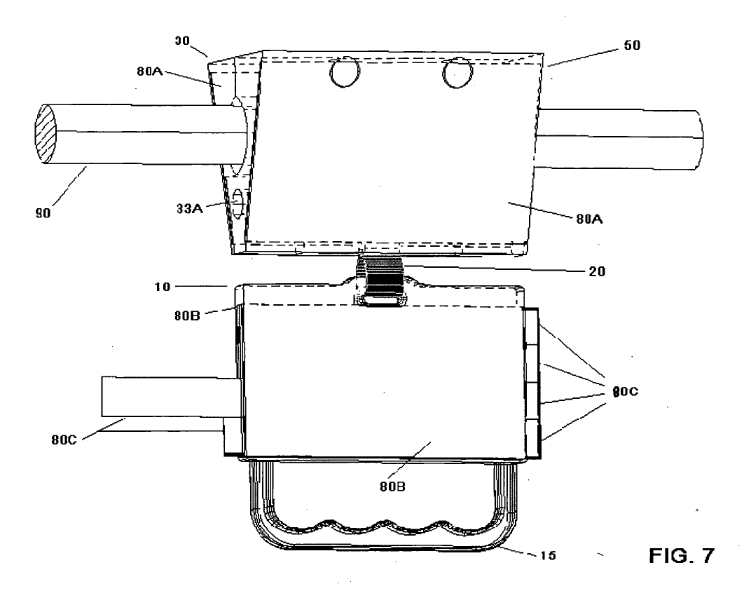

The entire present invention as assembled on the handrail 90 is shown in FIG. 6 (with no advertisement sheets or tracts) and 7 (with advertisement sheets and tracts). Handrail 90 is part of the handrails in a bus or subway. As in FIG. 7, two stable advertisement sheets 80As are placed in gaps G1 and G2; other two stable advertisement sheets 80Bs are placed in gaps G3 and G5. Dispensing tracts 80Cs are placed in gap G4 with exposed ends lying outside handle part 10. In FIG. 7, one of the dispensing tracts 80Cs with contact information is being taken out from handle part 10. Notice that advertisement sheets and dispensing tracts should be produced fitting the size of gaps so that they can be easily placed in and replaced from gaps G1 to G5. People can hold on handhold portion 15, which has been shaped fitting people's hands, in any direction because handle part 10 and fixing part are connect by knitting strip ring 20.

The present invention is provided which may be easily adopted to any handrail in buses or subways by simply clamping the two fixing frames 50 and 30, and be easily inserted the advertisement sheets and tracts as desired into gaps. Advertisements sheets and tracts can be changed regularly without disturbing the device. The present invention allows people to read advertisements in it and take tracts away if desired, which allows a more effective way of transmitting information from advertisements to people.

While we have illustrated and described a present preferred embodiment of the invention, it is to be understood that the invention is not limited thereto and may be otherwise variously practiced within the scope of the following claims.

1. A handle with advertisement areas is combination with a pole in bus or subway, comprising:
multi pieces, said fixing part, handle part and knitting strip ring, said fixing part that is comprised of said two identical fixing frames which can fit to each other complementarily in opposite direction and be adapted to be engageable in clamping relationship to said handrail in bus or subway, and said hand part that allows people to hold on and connects to said fixing part through said knitting strip ring.

2. The handle with advertising areas of claim 1 further comprising:
means for retaining said advertisement sheets in said fixing part and handle part having said gaps being adapted to receive corresponding said advertisement sheets and each advertisement sheet being removably mounted in one of said gaps to maintain each said advertisement sheet in position in an associated part.

3. The handle with advertising areas of claim 1 further comprising: means for retaining said dispensing tracts in said handle part having said gaps being adapted to receive corresponding said dispensing tracts and said dispensing tracts being removably mounted in one of said gaps to maintain each said dispensing tract in position in an associated part and ready for people hold exposed end of a tract to take it out.

4. The handle with advertising areas in combination with a handrail in bus or subway, comprising:
multi pieces comprising a fixing part and handle part, said fixing part having two identical fixing frames being shell-like, complementary to one another, and engageable in clamping relationship to said handrail in bus or subway, and having complementary alignment means, said alignment means of said one fixing frame having said protruding parts locating, and receding parts receiving corresponding receding parts, and protruding parts of the other fixing frame, respectively, with said gaps in them for holding said advertisement sheets and tracts; and said handle part having a said handhold portion in shape fitting human's hand, said advertisement displaying faces, said gaps for holding said advertisement sheets and tracts, and a said hole for said knitting strip ring to go through.

5. The handle with advertising areas of claim 4 further comprising:
in two said fixing frames, said corresponding receptacles and bores lay linearly, allowing said fasteners to go through corresponding receptacles and bores to ensure two said fixing frames in a relative fixed position to each other, and allowing said knitting strip ring to go between two said fixing frames through said empty spaces formed by corresponding said receding parts in two said fixing frames and to connect to one of the said fasteners, so that said fixing part connects to said knitting strip ring, which also connects to said handle part.

6. The handle with advertising areas of claim 4 further comprising:
between two said fixing frames, said cylindrical-like empty space being formed by two said corresponding receptacles on two said fixing frames such that said handrail is received by said empty space and fixed in a fixed position relative to said fixing part.

7. The handle with advertising areas of claim 5 wherein: Said fasteners means comprised threaded screws receptacles and receiving bores in one said fixing frame and through said receiving bores and receptacles in the other fixing frame to secure two said fixing frames in clamped engagement around said handrail.

8. The handle with advertising areas of claim 5 wherein:
Said fastening means also comprises a locking means received on one end of the each said fastener.
